(19) United States
(12) Patent Application Publication
(10) Pub. No.: US 2015/0017014 A1
(43) Pub. Date: Jan. 15, 2015

(54) CORE FOR CASTING A HOLLOW COMPONENT

(71) Applicant: SIEMENS AKTIENGESELLSCHAFT, München (DE)

(72) Inventors: Fathi Ahmad, Kaarst (DE); Uwe Paul, Ratingen (DE)

(21) Appl. No.: 14/380,878

(22) PCT Filed: Dec. 18, 2012
(86) PCT No.: PCT/EP2012/075882

§ 371 Date: Aug. 25, 2014

(30) Foreign Application Priority Data
Mar. 7, 2012 (EP) 12158368.6

(51) Int. Cl. B22C 9/10; F01D 5/18

(52) U.S. Cl. CPC B22C 9/10; F01D 5/18; F05D 2230/211
USPC 416/232; 164/369

(57) ABSTRACT

A core (10) for casting a hollow component of a turbomachine. The core includes a first portion (12) for providing a shape to the component and a second portion (14) located outside of the component. The second portion (14) comprises a plurality of indentations (16) for preventing a breakage of the core (10) at a region proximal to the first portion (14).

### CROSS-REFERENCE TO RELATED APPLICATIONS

The present application is a 35 U.S.C. §§371 national phase conversion of PCT/EP2012/075882, filed Dec. 18, 2012, which claims priority of European Patent Application No. 12158368.6, filed Mar. 7, 2012, the contents of which are incorporated by reference herein. The PCT International Application was published in the English language.

### TECHNICAL FIELD

The present invention relates to a core for casting a hollow component, and more particularly for casting a hollow component such as a blade or vane for a turbomachine.

### TECHNICAL BACKGROUND

Casting is commonly used in aerospace and power generation industries such as for manufacturing a blade or a vane or a ring segment for a gas turbine. These blades, vanes or ring segments can have a complex shape (e.g. airfoil) which can be manufactured using a casting technique, such as investment casting technique. Very often such components have a hollow design to enable internal cooling during the operation of the turbomachine to withstand the high thermo-mechanical load.

The production of an investment cast gas turbine blade or vane involves producing a ceramic casting mold having an outer ceramic shell with an inside surface corresponding to the airfoil shape, and in case of a hollow component one or more ceramic cores positioned within the outer ceramic shell corresponding to interior cooling passages to be formed within the airfoil. Molten alloy is poured into the ceramic casting vessel and is then allowed to cool and to solidify. The outer ceramic shell and ceramic core are then removed by mechanical or chemical means to reveal the cast blade or vane having the external airfoil shape and hollow interior cooling passages in the shape of the ceramic core.

As will be appreciated, internally cooled gas turbine blades or vanes can have several forms of trailing edge airflow exit. Currently, trailing edge cutback have a tear drop design which provide high efficiency, however casting of this design results very often in core breakage due to small or tiny geometries of the exit holes, which is required for component aerodynamical and/or performance reasons. Core breakage takes place at the trailing edge during ceramic core production, wax pattern production, shell mold production or during the casting process resulting in decrease in manufacturing yields and scrapping of parts due to the small thickness at the trailing edge region.

One way to avoid breakage is to increase the thickness of the core at the trailing edge, however this results in an increase in the size of exit holes at the trailing edge resulting in an increase in the airflow consumption and/or performance loss wherein both are not favorable.

Another way be prevent core breakage during casting is to allow the core to float at the trailing edge. However, this technique increases risk of large trailing edge end wall thickness deviations at a pressure side and/or a suction side. This results in a direct impact on the overall life and performance of the component. In addition, it is difficult to coat and/or repair the component since the pressure side of the trailing edge is thin.

### SUMMARY OF THE INVENTION

It is therefore an object of the present invention to provide a core for casting a hollow component which does not break during the casting process, even with very small exit holes features.

The object is achieved by providing a core for casting a hollow component of a turbomachine according to the invention.

According to the invention, a core for casting a hollow component of a turbomachine is provided. The core includes a first portion for providing a shape to the component and a second portion which is located outside the component. There is an outer shell placed over the core.

The second portion of the core includes a plurality of indentations for preventing breakage of the component at a region proximal to the first portion. By having a plurality of indentations, the second portion of the core, which is located outside the component, is made weak as compared to the first portion. In case of mechanical load during manufacturing steps, this results in breakage of the second portion rather than the first portion, wherein the mechanical load is reduced in the first portion thereby preventing breakage of the core area which is within the component.

In one embodiment, the second portion includes a plurality of slots, bands, grooves or combinations thereof, which further weakens the second portion, especially an end distal from the trailing edge of the component.

In one embodiment, the second portion of the core is formed during a core injection process, which makes it easier to manufacture the core and does not require additional process to manufacture the second portion.

The plurality of slots, bands, grooves and the like are formed by grinding or cutting the second portion, by cutting or grinding a desired shape or structure in the second portion. This can be performed after the core injection process.

The plurality of indentations are formed by grinding or cutting the second portion. Grinding or cutting provides desired indentations with fine finish and accurate dimensions. In addition, grinding enables making shallow cuts in the second portion.

In one embodiment, the second portion of the core is proximal to a trailing edge of the component, which enables preventing the breakage of the trailing edge region in the first portion of the core.

In another embodiment, the component is a blade or a vane, which is in the shape of an airfoil and contains a trailing edge which has a possibility of breaking a fin at the trailing edge due to breakage of the core during casting.

In one embodiment, the plurality of indentations in the second portion further weaken the second portion since the second portion is mechanically loaded during the casting process causing it to break and thus reducing the mechanical load at the trailing edge in the first core portion of the component.

### BRIEF DESCRIPTION OF THE DRAWINGS

The above-mentioned and other features of the invention will now be addressed with reference to the accompanying drawings of the present invention. The illustrated embodiments are intended to illustrate, but not limit the invention. The drawings contain the following figures, in which like numbers refer to like parts, throughout the description and drawings.

FIG. 1 is a schematic diagram of a core for casting a hollow component;

FIG. 2 is an exemplary core for casting the hollow component, in accordance with aspects of the present invention,

FIG. 3a is a schematic diagram of a fragment of a second portion of the core of FIG. 2, in accordance with aspects of the present invention.

FIG. 3b is a schematic diagram of another fragment of a second portion of the core as seen in FIG. 2

### DESCRIPTION OF EMBODIMENTS

Embodiments of the present invention relate to a core for casting a hollow material for a turbomachine and more particularly to a core for casting a blade or vane for a turbomachine, which are in a shape of an airfoil. The turbomachine may include a gas turbine, a steam turbine, a turbofan and the like.

FIG. 1 is a schematic diagram depicting a core for casting hollow components such as a blade or a vane of a turbomachine.

The core includes a first portion 12 and a second portion 14. The first portion 12 provides a desired shape to the component. The first portion 12, and preferably not the second portion, also includes a plurality of structures 15 such as pins, fins or channels placed and configured to form internal structures in the blade or vane of a turbomachine.

In accordance with aspects of the present technique, the core 10 may be formed from a ceramic material. The core 10 is generally formed using a core injection process, such as the fusible core injection molding known in the art. The core injection molding process is a specialized plastic injection molding process used to mold internal cavities or undercuts that are not possible to mold with demoldable cores.

It may be noted that a shell surrounds the core 10 to form a cavity into which a melted material, which is at a high temperatures from about 1250° C. degrees Centigrade to about 1850 degrees Centigrade is poured and. Therefore, the shell may also is formed from a material such as ceramic or other material capable of withstanding such high temperatures.

Subsequently when the melted material cools down and solidifies, the hollow component such as the blade or the vane is obtained with a desired shape and internal structures, like pins, fins and ribs are formed. Typically, these internal structures are present at a trailing edge portion of the blade or vane of the turbomachine, toward or, adjacent the second portion of the core to allow cooling of the blade or vane.

In accordance with aspects of the present technique, the second portion 14 of the core 10 is outside the actual cast part of the hollow component. The second portion 14 is proximal to the trailing edge of the cast component.

The trailing edge of the blade or vane includes a plurality of exit holes for allowing the cooling air to exit the blade or the vane. These exit holes are generally formed during the casting process due to a presence of struts (not shown in FIG. 1) which are present at a region proximal to the second portion 14.

As will be appreciated, the thickness of the struts should be as small as possible for aerodynamic reasons. It is due to the presence of thin struts forming exit holes that the core 10 breaks during the casting process.

As previously noted the region of the core 10 susceptible to breakage is within the part cast of the hollow component and it is proximal to the second portion 14. More particularly, the region of the core 10 is the portion of the core 12 for casting the trailing edge part of the component.

As noted earlier, the melted material is poured into the cavity formed between the core 10 and the shell. The melted material exerts thermo-mechanical load on the core and especially more on the region wherein the exit holes are formed, which is proximal to the second portion 14 of the core 10. The plurality of indentations on the second portion 14, make the second portion 14 weaker than the region of the first portion 12 forming the trailing edge of the cast component.

The second portion 14 is outside the cast part and therefore when the load of the melted material increases, the plurality of indentations 16 which weaken the second portion 14 break, which decreases the load on the other portions, such as the trailing edge portion of the first portion 12 of the core 10 for the purpose of casting the component such as the blade or the vane.

In accordance with aspects of the present technique, the plurality of indentations 16 may be in a form of comb like structure.

In addition, the second portion 14 of the core 10 may include indentations 16 which may be in the form of plurality of slots, grooves, bands or combinations thereof. Typically, any structure which may weaken the second portion of the core may be designed.

The plurality of indentations 16 may be formed during the core injection process. Alternatively, the indentations 16 may be formed after the core injection process by processes such as, but not limited, to grinding and cutting. The second portion 14 is ground or cut to create desired shape and size of the indentations 16.

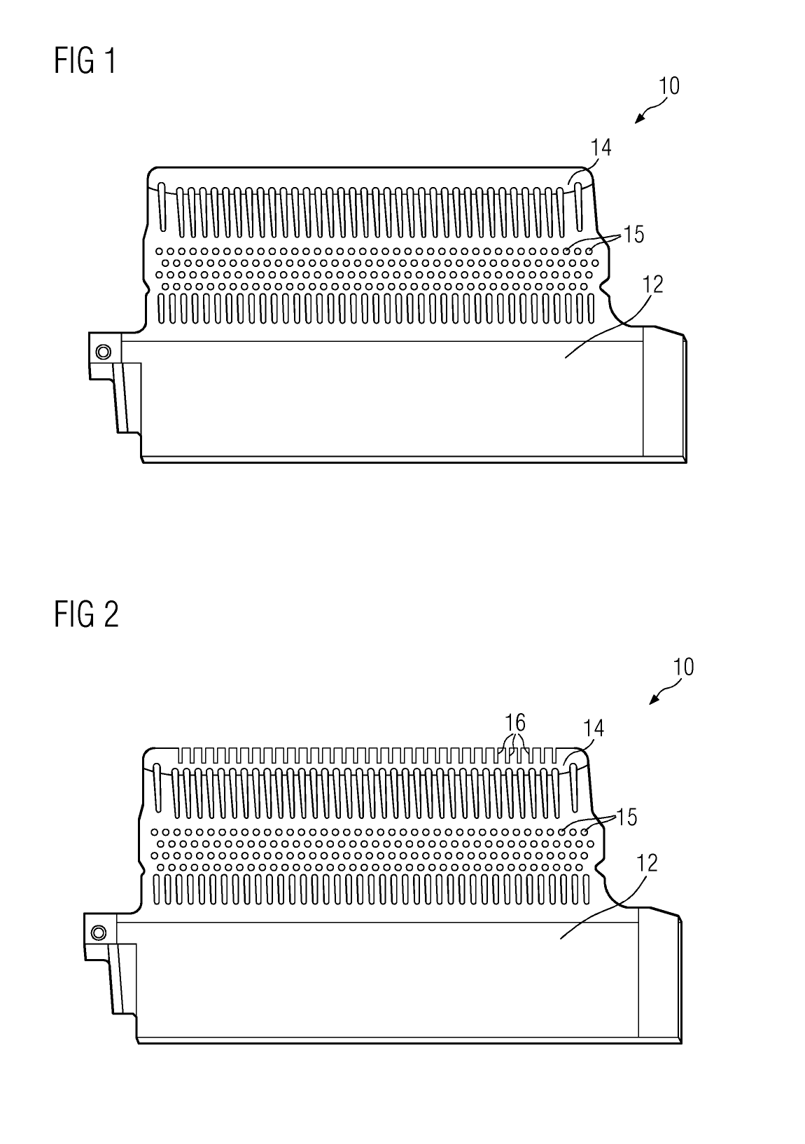

FIG. 2 shows a schematic diagram of a fragment of an exemplary core 10 in accordance with aspects of the present technique. The core 10 includes the first portion 12 and the second portion 14. The second portion 14 includes a plurality of indentations 16 to prevent breakage of the core 10 at a region proximal to the first portion 12.

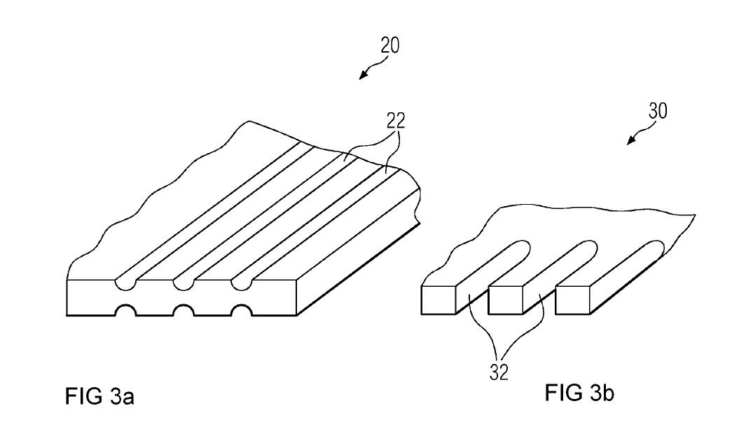

FIG. 3a is a schematic depiction of a section 20 of the second portion 14 of the core 10 in accordance with aspects of the present technique. In the section 20, a plurality of grooves 22 are formed in the second portion 14. The plurality of grooves 22 extend in a direction radially outward in the second portion 14 beyond the exit holes in the hollow component. Section 20 could be embodied in the second portion 14 in FIG. 1, but not in FIG. 2.

Another embodiment 30 of a section of the second portion 14 is shown in FIG. 3b. The second portion 14 includes a plurality of slots 32 to weaken the second portion 14. In FIG. 3b, the slots 32 are the same as the grooves 16 in FIG. 2.

The plurality of grooves 22 in FIG. 3a and slots 32 in FIG. 3b may be formed by grinding or cutting the second portion of the core 10. Any other design which weakens the core may be used.

Although the invention has been described with reference to specific embodiments, this description is not meant to be construed in a limiting sense. Various modifications of the disclosed embodiments, as well as alternate embodiments of the invention, will become apparent to persons skilled in the art upon reference to the description of the invention. It is therefore contemplated that such modifications can be made without departing from the embodiments of the present invention as defined.

1. A core for casting a hollow component of a turbomachine, the core comprising:
a first portion for providing a shape to the component;
a second portion located outside of the component, the second portion comprises a plurality of indentations at a region proximal to the first portion, and the indentations are shaped and sized for preventing a breakage of the core.

2. The core according to claim 1, wherein the indentations of the second portion include at least one of a plurality of slots, bands, grooves or combinations thereof.

3. The core according to claim 1, wherein the second portion of the core is formed during a core injection process.

4. The core according to claim 1, wherein the indentations including the at least one of the plurality of slots, bands or grooves or combination thereof are formed by grinding or cutting the second portion.

5. The core according to claim 1, wherein the plurality of indentations are formed by grinding or cutting the second portion.

6. The core according to claim 1, wherein the first portion of the core of the component has a trailing edge with respect to an intended direction of rotation of the component; and
the second portion is proximal to the trailing edge of the first portion.

7. The core according to claim 1, wherein the core is configured for casting the hollow component as a blade or a vane.

8. The core according to claim 1, wherein the plurality of indentations are configured to weaken the second portion of the core for preventing breakage of the core.

9. A blade or vane for a turbomachine, wherein the blade or vane is formed using the according to claim 1.
